(19) United States
(12) Patent Application Publication
(10) Pub. No.: US 2009/0273105 A1
(43) Pub. Date: Nov. 5, 2009

(54) METHOD AND SYSTEM FOR PERFORMING AN INTERFACIAL REACTION IN A MICROFLUIDIC DEVICE

(75) Inventors: D. Tyler McQuade, Tallahassee, FL (US); Jeremy L. Steinbacher, Mansfield, PA (US); Elizabeth Quevedo, Corpus Cristi, TX (US)

Correspondence Address: CHOATE, HALL & STEWART LLP, TWO INTERNATIONAL PLACE, BOSTON, MA, 02110, US

(73) Assignee: CORNELL RESEARCH FOUNDATION, Ithaca, NY (US)

(21) Appl. No.: 11/914,408

(22) PCT Filed: May 23, 2006
(86) PCT No.: PCT/US06/19839

§ 371 Date: Aug. 12, 2008

Related U.S. Application Data
(60) Provisional application No. 60/683,656, filed on May 23, 2005.

(51) Int. Cl. B01J 19/00; C08G 69/08; B29C 70/70

(52) U.S. Cl. 264/4; 528/310; 422/131

(57) ABSTRACT

A microfluidic system for performing interfacial reactions can comprise at least one pump in fluid communication with a tube. A first fluid is injected into the tube so that its flow is laminar and continuous. A second fluid is injected in discrete amounts into the tube into the stream or flow of the first fluid. In other embodiments, discrete amounts of the second fluid are introduced into the channel first, then the first fluid is injected so that it creates a region of substantially laminar fluid flow around the discrete amounts of the second fluid. After the two fluids are in contact, a reaction occurs. The system can be configured so that the second fluid solidifies to form a capsule around the first fluid or vice versa. Other interfacial reactions also can be accomplished using the disclosed microfluidic systems and methods.

### CROSS-REFERENCE TO RELATED APPLICATION

This utility patent application claims the benefit of U.S. Provisional Application No. 60/683,656 filed on May 23, 2005, the entire disclosure of which is incorporated herein for any and all purposes.

### STATEMENT REGARDING FEDERALLY SPONSORED RESEARCH OR DEVELOPMENT

This invention was made with Government support from the Department of the Army/Army Research office under Grant No. DAAD19-02-1-0275. The Government has certain rights in the invention.

### BACKGROUND OF THE INVENTION

Unique fluid fields generated in microfluidic devices can control self-assembly, (Kenis, P. J. A.; Ismagilov, R. F.; Whitesides, G. M. Science 1999, 285, 83-85) crystallization, (Zheng, B.; Tice, J. D.; Ismagilov, R. F. Adv. Mater. 2004, 16, 1365-1368) (Zheng, B.; Tice, J. D.; Roach, L. S.; Ismagilov, R. F. Angew. Chem.-Int. Edit. 2004, 43, 2508-2511) and reagent mixing (Zheng, B.; Tice, J. D.; Ismagilov, R. F. Anal. Chem. 2004, 76, 4977-4982). Quake et al. (Thorsen, T.; Roberts, R. W.; Arnold, F. H.; Quake, S. R. Phys. Rev. Lett. 2001, 86, 4163-4166), Weitz et al. (Link, D. R.; Anna, S. L.; Weitz, D. A.; Stone, H. A. Phys. Rev. Lett. 2004, 92), and Nisisako et al. (Okushima, S.; Nisisako, T.; Torii, T.; Higuchi, T. Langmuir 2004, 20, 9905-9908) and US 2005/0172476 A1 showed for example that emulsion droplets can be formed and organized into a wide range of patterns within microfluidic channels. Emulsions are created by mixing two immiscible liquids, water and oil, to form either an oil-in-water or a water-in-oil emulsion at the junction where the two liquids meet. To date, such emulsions have been captured by coacervation (Nalagawa, K.; Iwamoto, S.; Nakajima, M.; Shono, A.; Satoh, K. J Colloid Interface Sci. 2004, 278, 198-205), by photoinitiated polymerization to create solid beads (Nisisako, T.; Torii, T.; Higuchi, T. Chem. Eng. J 2004, 101, 23-29), or by a double emulsion method to create hollow capsules (Utada, A. S.; Lorenceau, E.; Link, D. R.; Kaplan, P. D.; Weitz, D. A. Science 2005, 308, 537-541). All three methods use a two-step procedure where the droplet is first produced at a fluid junction and then polymerized down stream.

An alternate approach to forming capsules within a microfluidic device relies on interfacial polymerization. By adding monomers and crosslinkers to each phase, the emulsions can be captured as microcapsules in-situ. The overall result is semi-permeable, micron sized capsules that can be collected. Interfacial polymerization within microfluidic devices has been achieved to yield fibers trapped within the device (Kenis, P. J. A.; Ismagilov, R. F.; Takayama, S.; Whitesides, G. M.; Li, S. L.; White, H. S. Accounts Chem. Res. 2000, 33, 841-847), but interfacial polymerization has been reported to clog channels (http://www.eleves.ens.fr/home/grasland/rapports/stage4.pdf).

Ideally, fluidic devices should allow for rapid and cost-effective prototyping. Materials currently employed to create microfluidic devices include elastomers, glass, and silicon, which are etched to form channels having a rectangular cross-section. Two materials most popularly used to make microfluidic devices compatible for organic reactions are “liquid Teflon” (Rolland, J. P.; Van Dam, R. M.; Schorzman, D. A.; Quake, S. R.; DeSimone, J. M. J. Am. Chem. Soc. 2004, 126, 2322-2323) and those made from silicon/glass (Becker, H.; Gartner, C. Electrophoresis 2000, 21, 12-26). These approaches, however, require expensive monomer synthesis or specialized techniques, and the resulting microfluidic devices are easily clogged with polymer debris.

One way to address this problem is disclosed in US 2005/003621 A1. This published application discloses a microreactor having a complex coaxial multicylinderical structure which enables the coaxial lamination of a plurality of fluids. At least two fluids in the system react and at least one fluid does not react. The non-reacting fluid prevents the reaction product of the other two fluids form clogging the channel.

What is needed in the art is a microfluidic system in which fluids can react without clogging the system without the use of a complex system and a fluid not participating in the reaction.

### BRIEF SUMMARY OF THE INVENTION

To overcome these drawbacks, we report a microfluidic system using common laboratory tubing and needles. Herein, we describe the use of interfacial polymerization to create fluid-filled spheres that are captured as they are formed in a new simple microfluidic device. Other interfacial reactions also can be accomplished using the disclosed microfluidic systems and methods.

A simple microfluidic system for performing interfacial reactions can comprise at least one pump in fluid communication with a tube. Preferably, the tube is substantially cylindrical. A first fluid is injected into the tube so that its flow is laminar and continuous. A second fluid is injected into the tube into the stream or flow of the first fluid. Preferably, the second fluid is injected in discrete amounts. In some embodiments, the first fluid, having a continuous laminar flow is injected first so that the second fluid is injected directly into the flow of the first fluid. In other embodiments, discrete amounts of the second fluid are introduced into the channel first, then the first fluid is injected so that it creates a region of substantially laminar fluid flow around the discrete amounts of the second fluid. After the two fluids are in contact, a reaction occurs.

In some embodiments of the invention, the fluids react to form a solid. The system can be configured so that the second fluid solidifies to form a capsule around the first fluid or vice versa. Solidification of a fluid to form a capsule around another fluid using the disclosed system can also be accomplished via polymerization, a change of temperature of one or more of the fluids, or cross linking. In same embodiments, other, and sometimes multiple, reactions occur within the droplet of second fluid.

The disclosed methods enable interfacial reactions to occur with less likelihood of a clog forming in the tubing than in prior art devices. Furthermore, if a clog does form in the tube, the tube can be replaced in the system easily and inexpensively. We have found that the systems and methods disclosed herein are especially well-suited for forming capsules and hollow fibers via interfacial polymerization. However, embodiments of the invention can be used to perform any interfacial reaction, including, but not limited to, phase transfer catalyzed reactions.

### BRIEF DESCRIPTION OF THE SEVERAL VIEWS OF THE DRAWINGS

In the detailed description of the preferred embodiments of the invention presented below, reference is made to the accompanying drawings, in some of which the relative relationships of the various components are illustrated, it being understood that orientation of the apparatus may be modified. For clarity of understanding of the drawings, relative proportions depicted or indicated of the various elements of which disclosed members are comprised may not be representative of the actual proportions, and some of the dimensions may be selectively exaggerated.

FIG. 1 shows one embodiment of a system according to the present invention;

FIG. 2 is a partial cross-section view of a tube through which there is laminar flow of a fluid and into which an organic solution is being injected, according to one embodiment of the present invention;

FIG. 3 is a partial cross-section view of a tube through which there is laminar flow of a fluid and into which an organic solution with monomer and solute or suspension is being injected, according to one embodiment of the present invention;

FIG. 4 is a partial cross-section view of a tube through which there is laminar flow of a fluid and into which an organic solution with monomer and a water solution containing solute or suspension is being injected, according to one embodiment of the present invention;

FIG. 5 shows another embodiment of a system according to the present invention;

FIG. 6 is a partial cross-section view of the microreactor of FIG. 5;

FIG. 7 is another partial cross-section view of the microreactor for FIG. 5;

FIG. 8 is a partial cross-section view of PVC tubing through which there is laminar flow of an aqueous solution and into which an organic solution is being injected, according to one embodiment of the invention;

FIG. 9 is a photograph of a fluidic device according to an embodiment of the invention including needle and dye-filled organic droplets dispersed in the continuous aqueous phase;

FIG. 10 is a phase diagram depicting the flow regimes of a system according to an embodiment of the invention as a function of Reynolds and organic flow rate;

FIG. 11 shows four light microscope images of capsules in water formed according to the present invention;

FIG. 12 is a chart depicting the array of capsules sizes created over a range of continuous flow rates; and

FIG. 13 is two SEM images of microcapsules prepared according to one embodiment of the present invention.

### DETAILED DESCRIPTION OF THE INVENTION

A simple microfluidic system for performing interfacial reactions can comprise at least one pump in fluid communication with a tube. Preferably, the tube is substantially cylindrical. A first fluid is injected into the tube so that its flow is laminar and continuous. Preferably the Reynolds number of the first fluid is <2500 and even more preferably <1000. A second fluid is injected into the tube into the stream or flow of the first fluid. Preferably, the second fluid is injected in discrete amounts. In some embodiments, the first fluid, having a continuous laminar flow is injected first so that the second fluid is injected directly into the flow of the first fluid. In other embodiments, discrete amounts of the second fluid are introduced into the channel first, then the first fluid is injected so that it creates a region of substantially laminar fluid flow around the discrete amounts of the second fluid. After the two fluids are in contact, a reaction occurs.

In some embodiments of the invention, the fluids react to form a solid. The system can be configured so that the second fluid solidifies to form a capsule around the first fluid or vice versa. Solidification of a fluid to form a capsule around another fluid using the disclosed system can also be accomplished via polymerization, a change of temperature of one or more of the fluids, or cross linking. In same embodiments, other, and sometimes multiple, reactions occur within the droplet of second fluid.

The disclosed methods enable interfacial reactions to occur with less likelihood of a clog forming in the tubing than in prior art devices. Furthermore, if a clog does form in the tube, the tube can be replaced in the system easily and inexpensively. We have found that the systems and methods disclosed herein are especially well-suited for forming capsules and hollow fibers via interfacial polymerization. However, embodiments of the invention can be used to perform any interfacial reaction, including, but not limited to, phase transfer catalyzed reactions.

The tubing can be comprised of any suitable material, such as, but not limited to, PVC and HPLC tubing. In some embodiments the tubing has at least a portion that is transparent to a radiation having a frequency within a range. When the tubing contains fluids reactive when exposed to radiation having a frequency with in the range and the portion is exposed to radiation having a frequency within the range, the radiation can cause the fluids to react. In some embodiments, the radiation comprises UV or IR light. In experiments performed thus far, tubing having an inner diameter of 865 microns to 1.6 mm has been used to produce capsules having diameters from 1 micron to 1 mm.

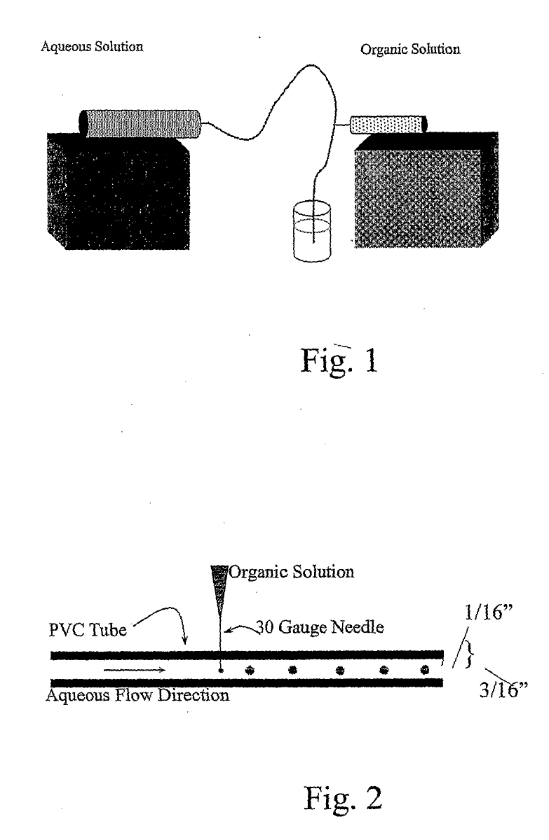

The exemplary system shown in FIGS. 1 and 2 utilizes two pumps. The pumps, which can be syringe pumps or any other suitable pumps, such as electrokinetic pumps, introduce fluids into the tube via any suitable injector, such as a needle, capillary or HPLC injector, just to name a few examples. The injector can be used to inject a measured amount of the fluids. The two pumps need not be the same. Alternatively, one can envision a system that utilizes a single pump to introduce multiple distinct solutions into the tube. Any number of pumps may be used. Multiple pumps may be desired for a variety of reasons, especially in systems where more than two fluids are injected.

The injecting of discrete amounts of a second fluid can be accomplished by configuring the injector of the second fluid to pump the second fluid in small discrete measured amounts (droplets). Alternatively, the injecting of discrete amounts of a second fluid can be accomplished by configure the injector to pump the second fluid relatively continuously. When the injector is configured to continuously pump the second fluid, the second fluid can break into discrete droplets via capillary forces. As it enters the fluid stream of the first fluid. In this case, the size of the droplets can be in part determined by the difference between the flow rate of the first fluid and the flow rate of the second fluid and/or the altering of the interfacial tension between the first and second fluids.

The fluid junction can occur at the wall of the tubing in which the interfacial reaction will take place, in the middle, or anywhere in between. Preferably, however the second fluid is injected into the tubing so that it is completely surrounded by the first fluid, i.e. there is contact between the first fluid and the wall but no contact between the second fluid and the wall. This is to prevent clogging. When only one fluid (the second fluid) is injected into the first fluid it may be advantageous to inject the second fluid into the center of the tubing. When multiple fluids are injected into the first fluid, it may be advantageous to inject these fluids off-center in the tubing. The fluid junction in some embodiments is, but does not have to be, orthogonal. The junction can be any angle with respect to the long axis of the tube. A multi-fluid junction may allow for two fluids to be combined in a third as a method to allow reactions that yield insoluble products to be performed without clogging the channels. In addition, the many fluid junctions could meet at the same or different locations along the tube. This would allow the introduction of many different fluids. The fluids that meet at a junction can be immiscible or miscible. The amount of mixing will depend on the properties of the fluids, such as the Reynolds number, the capillary number, and the flow rate.

When a system and/or method embodying the invention are used to form capsules via interfacial polymerization, different shapes can be created by altering the fluid or flow properties so that the colliding fluid streams form a laminar, transitional, or droplet phase. When a laminar phase or flow is form by the collision of two fluids, an interfacial polymerization will yield a hollow fiber or tube. Hollow tubes result when the depth of polymerization is less than the radius of the stream. If a bulk polymerization was performed en lieu of the interfacial polymerization a solid fiber would be formed instead of a hollow tube. As an example, a solid fiber could easily be achieved by using a pure monomer carrying a photoactive initiator in the disperse phase. As the laminar flow pass through light of a prescribed wavelength the polymerization would be initiated resulting in a solid fiber.

In one embodiment two co-linear streams of fluid within the laminar fluid flow react with the first fluid in the laminar flow and form two fibers. The system can be configured so that the two collinear streams react with each other to comprise a single fiber having two sections. Each can have distinct properties.

Interfacial or bulk polymerization of colliding flows in the transitional phase will yield shapes that are in between fibers and spheres. The ends of these shapes will be hemispheres whereas the center will be fiber shaped. Interfacial of bulk polymerization of colliding flows in the droplet phase will yield monodisperse capsules, i.e., any enclosed hollow structure. The capsules may be substantially spherical or oblong. One way to alter the flow properties is to alter the shape of the fluid junction. Junctions that intersect flat at 90° will yield tubes, oblate shapes, and beads. Junctions with non-90° angles will yields tears (<90°) and tubes (180°), depending on the Reynolds number and capillary number.

Sizes of capsules ranging from approximately 5 nm to 100 s of microns in diameter can be achieved using the described invention. The size of the capsule depends on the size of the injector, the size of the tubing, and the flow rates of the disperse phase and the continuous phase. Using a metered pumping device, droplets of carefully defined volume can be produced.

The interfacial polymerizations can be any condensation polymers including but not limited to, polyureas, polyamides, polyurethanes, and polycarbonates. The interfacial polymerizations can be any radical or metathesis polymerization. When using the disclosed methods and systems to form capsules, essentially any material used to create capsules via interfacial methods can be used (see Microencapsulation: processes and applications; [proceedings] edited by Jan E. Vandegaer. Published: New York, Plenum Press [1974]).

Many materials can be captured within the center of the capsules including small molecules such as drugs, flavorants, pesticides, odorants; polymeric materials such as polymer bound catalysts, enzymes, photoactive materials, sensory active materials; mixtures of molecules and materials; cells. Capsule interiors can be filled with both polar and non-polar fluids and with both suspended and soluble materials.

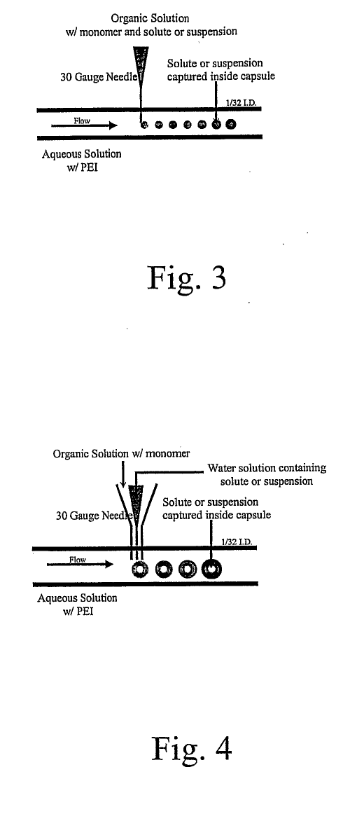

As shown in FIG. 3, a solute or finely divided solid is mixed with the disperse phase containing a monomer. This complex mixture is then collided with a continuous phase in the laminar, transitional, or droplet phase to yield filled hollow fibers, plugs or capsules, respectively.

Using a needle-in-needle approach, water-in-oil-in-water (or the inverse oil-in-water-in-oil) laminar, transitional, and droplet phases can be achieved. As shown in FIG. 4, in which droplets are shown for ease, interfacial polymerization of the outer layer will yield a water-in-oil filled capsule. Judicious choice of other configurations could yield simple shells, multishells or multilayered solids. Simple shells would be achieved by performing a photopolymerization, for example, of a monomer within the oil phase. Multishells would be achieved by performing an interfacial polymerization between the inner and outer water phases. The multilayered materials could be constructed by polymerizing the inner and out phases. The number of layers could easily be expanded by increasing the number of coaxial flows.

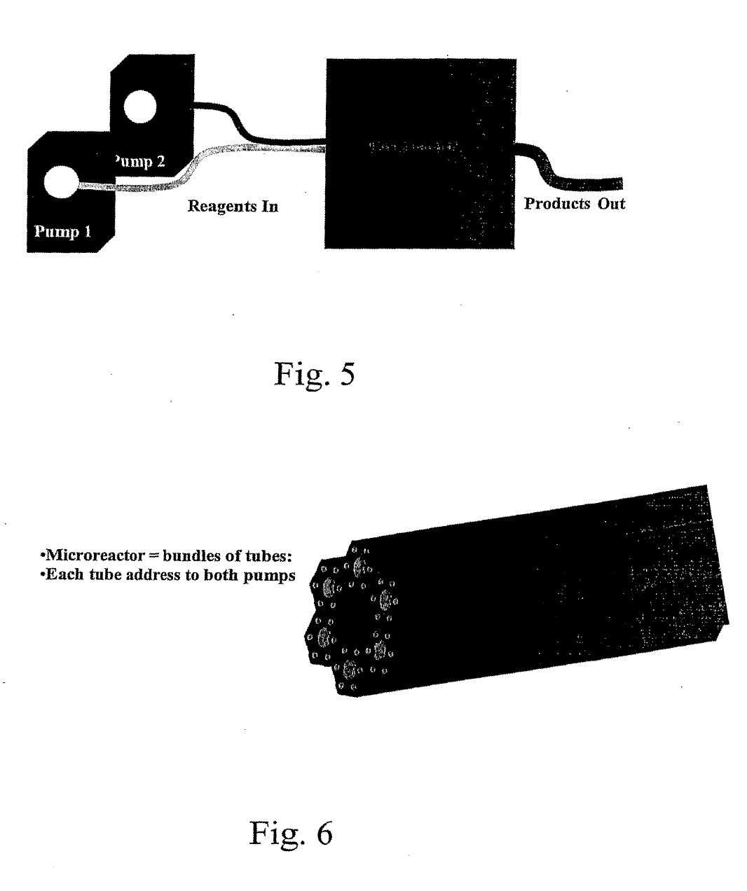

FIG. 5 shows an alternative system that embodies the invention. A microreactor will consist of fluidic devices (described below) connected to at least one pump, but more conventionally two or more pumps. The pumps will inject fluids containing reagents or neat reagents into the fluidic device. The pumps could consist of, but are not limited to, peristaltic pumps.

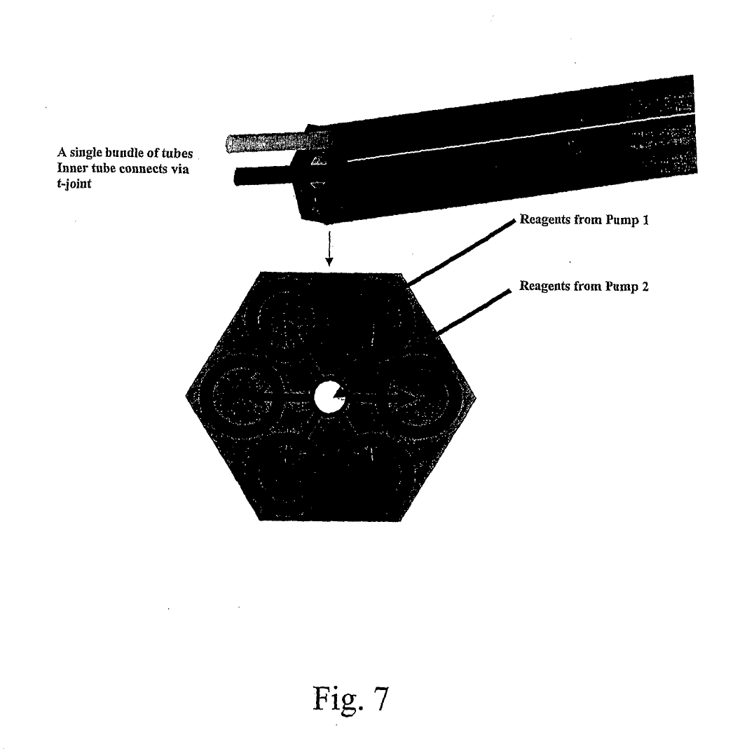

The fluidic inner workings of the microfluidic device can be constructed of a series of tubing bundles, illustrated in FIG. 6. The outer bundle of tubes will be connected to the central tubing via a junction, as shown in FIG. 7.

The tubes could be constructed of a wide variety of materials including metals such as copper and stainless steel, or polymeric materials such as PVC or Teflon, or inorganic materials such as glass.

The walls of the tubes could be unfunctionalized or functionalized with a variety of materials including metal, acid, base, enzymatic, or organo-catalysts or materials designed to alter surface properties such as hydrophobic or hydrophilic polymers or small molecules. Each of the inner/outer tube bundles can be further bundled in a manner allowing thermal control over each individual tube.

Generally, each individual tube could have an inner diameter ranging from approximately 1 nanometer to a centimeter and will normally be between 100's of nanometers to millimeters. The minimum and maximum sizes of the tubes may vary from the stated range and will depend on the system configuration. The tubes should not be so small as to cause backflow in the system nor so large that the Reynolds # of the fluid flow is unacceptable.

These tube bundles could exit into larger tubes to mitigate clogging. These larger tubes could be filled with fluids designed to further react with the products formed insides the initial tubes. For example, capsules formed via interfacial polymerization could be further coated by being exposed to a third reagent.

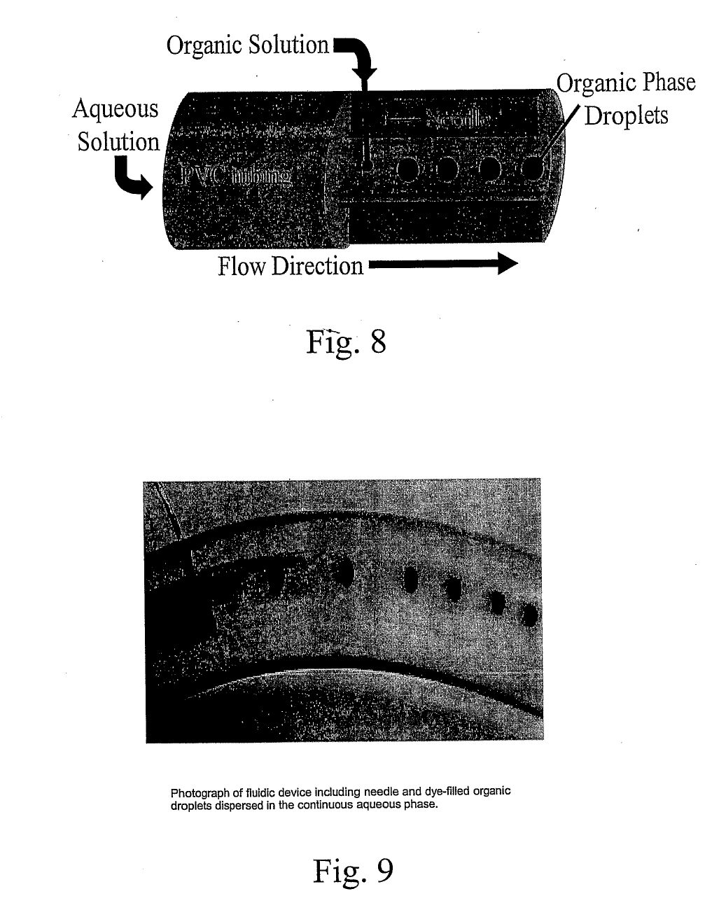

In one experiment illustrated in FIGS. 8 and 9, immiscible solutions were introduced into the device by two separate syringe pumps allowing independent flow rate variation. The continuous, aqueous phase was contained within a plastic 50 mL syringe mounted on a syringe pump (Harvard Apparatus Model 22). From the 50 mL syringe, the aqueous phase flowed through polyvinylchloride (PVC) tubing ( 1/16″ ID× 3/16″ OD, VWR International). The discontinuous, organic solution was dispensed from a 1 mL or 5 mL syringe mounted on a second syringe pump (Sage Orion M361) and introduced into the middle of the channel via a 30-gauge needle inserted through the wall of the PVC tubing.

The use of two syringe pumps allowed the flow rates of the solutions to be varied independently. Also, both syringe pumps were calibrated before use via timed pumping of known volumes. Using a luer-to-barb connector (Upchurch Scientific) the PVC aqueous flow tube was connected to the appropriate syringe. A 30-gauge needle (Becton-Dickinson) was attached directly to the organic-solution-containing syringe; the needle was then carefully inserted into the wall of the PVC tubing with the tip situated in the middle of the tube channel. When flow was initiated, the effluent and capsules were captured in a crystallizing dish partially filled with deionized water or collected directly into 20 mL sample vials.

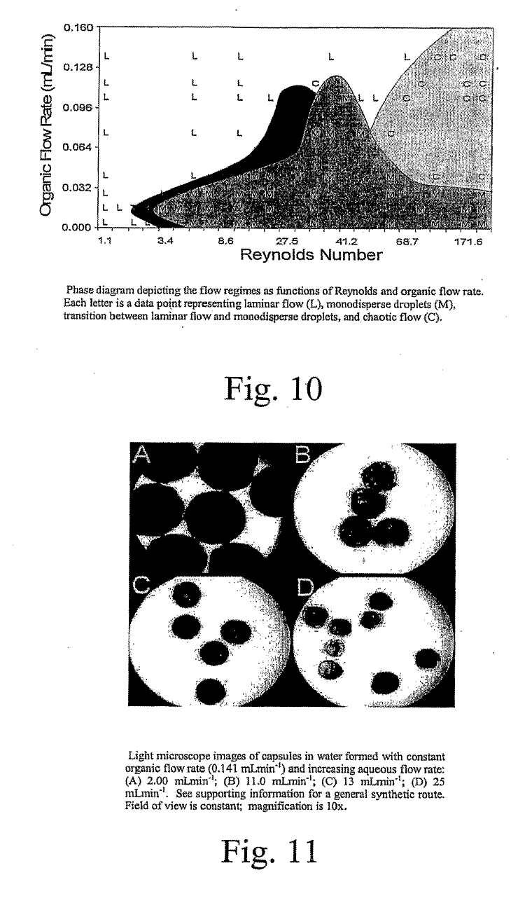

Flow behavior was measured as functions of organic and aqueous flow rates using a glycerol (Mallinckrodt AR) deionized water solution (30% w/v) to standardize the viscosity as the continuous phase and a 3:1 cyclohexane/chloroform mixture with 2% (v/v) Tween 80 (Aldrich) as the dispersed phase. FIG. 10 depicts the phase diagram illustrating the regions favorable for laminar flow (L), the transition between laminar flow and monodisperse droplets (T), monodisperse droplets (M), and chaotic flow (C). Each letter in FIG. 10 represents a data point collected. These results are consistent with those observed by Nisisako⁹ in a microfluidic device and illustrate that this simple tubular design exhibits phase behavior similar to standard microfluidic devices with rectangular channels.

Based on this initial success, we examined the interfacial polymerization of the monodisperse flow phase to generate a polyamide shell. We expected that the tubing/needle design would be preferable for performing interfacial polymerization over a prior art microfluidic device because the disperse phase is entirely surrounded by the continuous phase in our device, as seen in FIG. 8. Another advantage of our tubular device over a traditional microfluidic system is that should the device become clogged, we can simply replace the tubing, yielding a clean and functional apparatus within seconds.

To capture capsules, in the continuous phase (aqueous) polyethyleneimine (PEI, 50% in water) was used as the aqueous monomer to generate a 2.0% (v/v) mixture. A solution of sebacoyl chloride (SC, Acros, 92%) and trimesoyl chloride (TMC, 1, 3, 5-benzene tricarbonyl trichloride, Acros, 98%) as the monomers (1.34 M and 0.266 M, respectively) in 3:1 cyclohexane/chloroform comprised the dispersed phase (organic). Chloroform (J. T. Baker) and cyclohexane (Mallinckrodt Chemicals) were purchased and used from a commercially available source. Contact between the two solutions at the needle/tube junction resulted in oil filled, polyamide capsules.

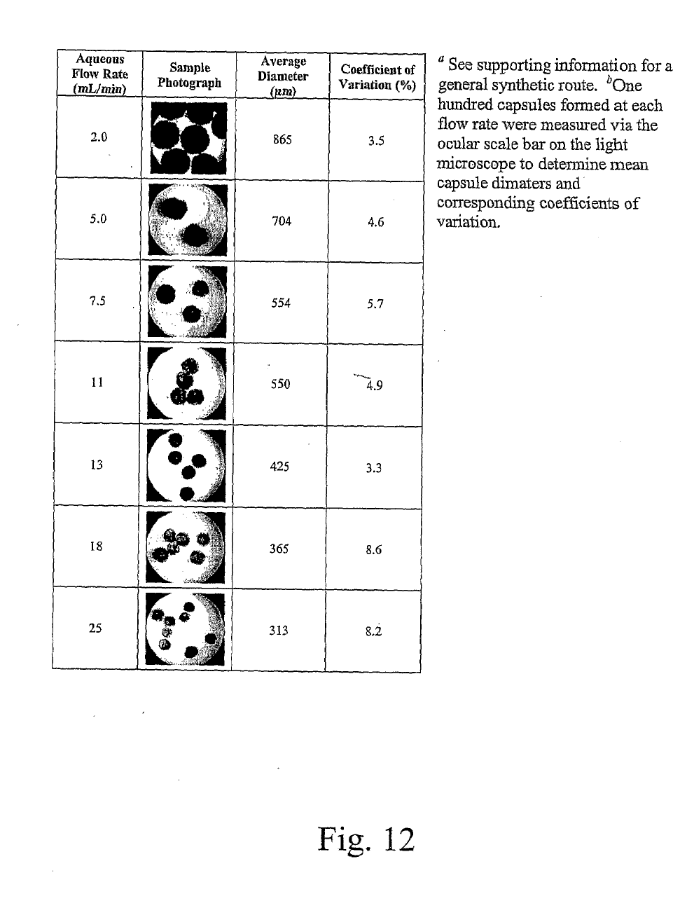

The effect of aqueous flow rate on capsule size was explored by holding the organic disperse flow rate constant and by varying the aqueous flow rate. It was found that capsule size gradually decreased with increased aqueous flow rate, and hence, with increasing Reynolds number, see FIG. 11. FIG. 12 depicts the array of capsule sizes created over a range of continuous phase flow rates. Over the entire 550 μm range, the capsule diameters maintained a CV of less than 9%. Moreover, we predict that by using a needle with a smaller aperture, monodispersed capsules with smaller diameters may form. Alternatively, the disperse phase flow rate could be slowed to decrease the capsule size.

The diameters of the capsules were measured within twelve hours of their formation via the ocular scale bar on an optical microscope (Leica DM IL). One hundred capsules were measured to determine mean capsule size and diameter coefficient of variation. The coefficient of variation (CV) is defined as follows:

CV=−(σ/μ)·100 (1)

where σ is the standard deviation of the diameter [μm] and μ is the number-average diameter of the diameter [μm] to give the coefficient of variation [%].
Reynolds Number (Re) is defined as follows:

Re=(d·ν·ρ)/η (2)

where d is the diameter of the channel [m], [symbol] is the flow rate [m/s], [symbol] is the density of the continuous phase [kg/m³], and [symbol] is the viscosity of the continuous phase [Pa·s]. The densities of all solutions were measured by weighing-by-difference of known volumes of solution. Viscosities were measured on a U-tube viscometer.

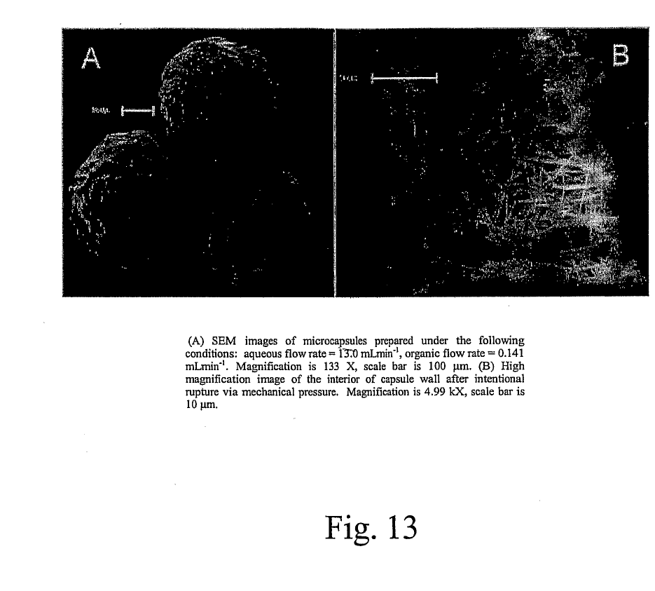

Once the emulsion surfaces were polymerized to form capsules, the polymerized mesocapsules were further characterized by scanning electron microscopy (SEM, LEICA 440) at 10 kV after sputter coating with palladium-gold to determine shell characteristics such as the surface topology and thickness. Photographs were obtained by a digital camera (Sony DSC-F717) mounted on the optical microscope and by secondary electron imagining with the SEM. The SEM images in FIG. 13A are representative of the entire population in this system and show well-defined capsules with robust shells. Furthermore, we noted that the diameter CV of the unpolymerized emulsions is smaller than the diameter CV of the capsules. We suggest that the higher CV is due to deformation of the shell as capsules exit the device.

The initially plastic capsules matured into hard spheres that have fibrous shells as observed in the SEM images of partially crushed capsules, see FIG. 13B.

We have demonstrated that simple flexible tubing and narrow gauge needles can replace classic elastomeric and hard material microfluidic devices. The new design yields laminar, transitional, droplet, and chaotic phases in the same way as classic devices. An added advantage of the disclosed system is that both the tubing and needle can be tubular and we can, therefore, introduce a disperse phase into the center of a continuous phase. This coaxial feature allows interfacial polymerization to occur without interference from the walls. We demonstrated that capsules with low CVs and a range of sizes are captured using interfacial polymerization. The capsule shells exhibit a unique fibrous structure that may be a ramification of polymerization within the fluid fields of the device.

Although the present invention has been described in considerable detail with reference to certain preferred versions thereof, other versions are possible. For example, three or more variable flow rate pumps can be used in a single system. Therefore, the spirit and scope of the appended claims should not be limited to the description of the preferred versions contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is only one example of a generic series of equivalent or similar features.

Any element in a claim that does not explicitly state “means” for performing a specified function or “step” for performing a specified function should not be interpreted as a “means” or “step” clause as specified in 35 U.S.C. §112.

1. A method of performing an interfacial reaction comprising:
injecting a first fluid into a channel so that a region of substantially laminar fluid flow is created;
and injecting discrete amounts of a second fluid into the region of substantially laminar fluid flow;
wherein the first fluid and the second fluid react.

2. The method of claim 1 wherein the second fluid is injected substantially orthogonally to the direction of the substantially laminar fluid flow.

3. The method of claim 1 wherein the discrete amount of the second fluid is determined at least in part by capillary forces.

4. The method of claim 1 wherein the channel comprises a tube.

5. The method of claim 1 wherein the channel is substantially cylindrical.

6. The method of claim 1 where the first fluid flows at a first rate and the second fluid is injected at a second rate and wherein the first rate is greater than the second rate and wherein the discrete amounts of the second fluid are determined at least in part by the difference between the first flow rate and the second flow rate.

7. The method of claim 1 wherein the first fluid and the second fluid react so that a capsule is formed.

8. The method of claim 7 wherein the capsule is substantially spherical.

9. The method of claim 7 wherein the capsule is substantially oblong.

10. The method of claim 1 wherein the first fluid flows at a first rate and the second fluid is injected at a second rate and wherein the second rate is greater than the first rate.

11. The method of claim 1 wherein interfacial tension exists between the first fluid and the second fluid and further comprising altering the interfacial tension between the first fluid and the second fluid.

12. The method of claim 10 wherein the first fluid and the second fluid react so that a fiber is formed.

13. The method of claim 12 wherein the fiber is substantially hollow.

14. The method of claim 12 wherein the fiber is substantially solid.

15. The method of claim 1 wherein the second fluid is injected substantially coaxially relative to the substantially laminar fluid flow.

16. The method of claim 1 wherein a discrete amount of the first fluid is injected.

17. The method of claim 16 further comprising capturing a material within the capsule.

18. The method of claim 17 wherein the material is captured within the capsule via injecting the material into the second fluid.

19. The method of claim 1 further comprising injecting a third fluid into the 20 region of substantially laminar fluid flow.

20. The method of claim 19 wherein the third fluid is injected into the second fluid.

21. The method of claim 20 wherein the third fluid reacts with the second fluid.

22. The method of claim 19 wherein the second fluid and the third fluid react with the first fluid.

23. The method of claim 19 wherein the third fluid reacts with the first fluid and the second fluid.

24. The method of claim 19 further comprising injecting a fourth fluid into the region of substantially laminar fluid flow.

25. The method of claim 19 wherein the third fluid is injected into the region of substantially laminar fluid flow so that droplets of the third fluid collide and react with the discrete amounts of the second fluid.

26. The method of claim 24 wherein all of the fluids react with any other fluid with which the fluid has contact.

27. The method of claim 20 wherein the third fluid is injected into the second fluid in discrete amounts.

28. The method of claim 20 wherein the third fluid comprises at least two fluid components and wherein the at least two fluid components are non-reactive with each other.

29. The method of claim 1 wherein the second fluid comprises at least two fluid 20 components and wherein the at least two fluid components are non-reactive with each other.

30. The method of claim 1 wherein the first fluid comprises at least two fluid components and wherein the at least two fluid components are non-reactive with each other.

31. The method of claim 30 wherein the two fluid components flow in sequence through the channel.

32. The method of claim 29 where the at least two fluid components flow in sequence through the channel.

33. The method of claim 28 wherein the at least two fluid components each react with the first fluid so that a fiber is formed.

34. The method of claim 33 wherein the fiber comprises at least two sections, each section being formed by a reaction product between one of the at least two fluid components and the first fluid.

35. A method of performing an interfacial reaction in a fluidic device comprising:
injecting a first fluid into a channel having walls so that a region of substantially laminar fluid flow is created and so that the first fluid contacts the walls;
injecting a second fluid into the region of substantially laminar fluid flow wherein the first fluid and the second fluid react.

36. The method of claim 35 wherein the second fluid flows continuously into the region of substantially laminar fluid flow.

37. The method of claim 35 wherein the first fluid flows at a first rate and the 20 second fluid flows at a second rate and wherein the first rate is greater than the second rate so that the second fluid breaks into droplets surrounded by the first fluid.

38. A method of performing an interfacial reaction in a fluidic device comprising:
injecting a first fluid into a channel so that a region of substantially laminar fluid flow is created; and
injecting a second fluid into the region of substantially laminar fluid flow at an angle of about 90°; wherein the first fluid and the second fluid react.

39. The method of claim 38 wherein the second fluid flows continuously into the region of substantially laminar fluid flow.

40. The method of claim 39 wherein the first fluid flows at a first rate and the second fluid flows at a second rate and wherein the first rate is greater the second rate so that 10 the second fluid breaks into droplets surrounded by the first fluid.

41. A method of performing a reaction in a fluidic device comprising:
injecting a first fluid into a channel so that a region of substantially laminar fluid flow is created, wherein a portion of the channel is substantially transparent to radiation having a frequency within a range;
injecting a second fluid into the region of substantially laminar fluid flows; and
exposing the substantially transparent portion to radiation having a frequency within the range, wherein the radiation causes a reaction to occur.

42. The method of claim 41 wherein the second fluid is injected upstream from 20 the substantially transparent portion.

43. A method of performing an interfacial reaction comprising:
injecting discrete amounts of a first fluid into a channel; and
injecting a second fluid into the channel so that a region of substantially laminar fluid flow is created around the discrete amounts of the first fluid;
wherein the first fluid and the second fluid react.

44. A method for solidifying a fluid into a desired form comprising:
injecting a first fluid into a channel so that a region of substantially laminar fluid flow is created;
injecting the second fluid into the region of substantially laminar fluid flow; and
solidifying the second fluid.

45. The method of claim 44 wherein the solidification is effected via polymerization.

46. The method of claim 45 wherein the polymerization is effected via exposure of the second fluid to UV light.

47. The method of claim 45 wherein the polymerization is effected via a change in temperature of the second fluid.

48. The method of claim 47 wherein the first fluid has a first temperature, wherein the second fluid has a second temperature, wherein the first temperature is below a solid phase transition temperature of the second fluid as the second fluid is injected and wherein the second temperature is above the solid phase transition temperature as the second fluid is injected.

49. The method of claim 44 wherein the solidification is effected via crosslinking.

50. The method of claim 47 wherein the temperature of the second fluid is increased via exposure to IR light.

51. A system for solidifying a fluid into a desired form comprising:
a channel;
a first injector in fluid communication with the channel, the first injector being configured to inject a first fluid into the channel so that a region of substantially laminar fluid flow is created;
a second injector in fluid communication with the channel, the second injector being configured to inject a second fluid into the region of substantially laminar fluid flow; and
a means for solidifying the second fluid.

52. A system for performing an interfacial reaction
a channel;
a first injector in fluid communication with the channel, the first injector being configured to inject a first fluid into the channel so that a substantially laminar fluid flow is created; and
a second injector in fluid communication with the channel, the second injector being configured to inject a discrete amount of a second fluid into the substantially laminar fluid flow.

53. The system of claim 52 wherein the second injector is configured to inject the second fluid orthogonally to the channel.

54. A method of forming a capsule comprising:
injecting a first fluid into a channel so that a region of substantially laminar fluid flow is created; and
injecting a second fluid into the region of substantially laminar fluid flow; wherein the first fluid and the second fluid react, thereby creating a capsule.

55. The method of claim 54 wherein the second fluid flows continuously into the region of substantially laminar fluid flow.

56. The method of claim 55 wherein the first fluid flows at a first rate and the second fluid flows at a second rate and wherein the first rate is greater than the second rate so that the second fluid breaks into droplets surrounded by the first fluid.
